(19) United States
(12) Patent Application Publication
(10) Pub. No.: US 2010/0080195 A1
(43) Pub. Date: Apr. 1, 2010

(54) MOBILE COMMUNICATION SYSTEM

(75) Inventors: Masayuki HARA, Kawasaki (JP); Tetsuta SAKABE, Kawasaki (JP); Kenichi KAMEI, Kawasaki (JP); Tatsuya URUSHIYAMA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/565,832

(22) Filed: Sep. 24, 2009

(30) Foreign Application Priority Data
Sep. 29, 2008 (JP) 2008-250367

(51) Int. Cl. H04J 3/00

(52) U.S. Cl. 370/336

(57) ABSTRACT

A mobile communication system including a plurality of base stations includes a radio communicator for communicating with mobile terminal devices with a plurality of carriers, and a communication controller for changing radio field intensity of the radio communicator; and a management device including: a storage for storing information of each of the base stations, the information including time slots and a number of registration requests from the mobile terminal devices in each communication area of the base station in accordance with the time slots, and an instructor for instructing to change radio field intensity of the plurality of carriers to the radio communicator in the base stations on the bases of the stored information in the storage when the number of the registration requests in the time slot exceed a specified predetermined threshold value.

### CROSS-REFERENCE TO RELATED APPLICATION

This application is based upon and claims the benefit of priority of the prior Japanese Patent Application No. 2008-250367, filed on Sep. 29, 2008, the entire contents of which are incorporated herein by reference.

### FIELD

The embodiments discussed herein are related to a mobile communication system including a plurality of base stations performing radio communication with mobile terminals.

### BACKGROUND

In the field of radio communication, a frequency band is allocated to a provider providing communication services. Each provider builds a radio communication system using frequencies within the allocated frequency band. For example, a mobile terminal system, which is one of mobile radio communication systems, is configured by a mobile terminal device including a verbal communication function, an e-mail transmission/reception function and the like, a plurality of base stations each forming a communication area, a radio network controller controlling communication in the plurality of base stations, and a core network provided at a higher level than the radio network controller and connected to other communication systems. Between mobile terminal devices and base stations, radio connection are established using a plurality of carriers belonging to the respective allotted frequency bands.

FIG. 1 is a diagram illustrating relationships between base stations and a plurality of carriers.

In the example illustrated in FIG. 1, two base stations each have mutually different communication areas #1 and #2. In each of the base stations, three carriers #1, #2, and #3 are prepared for. The mobile terminal device performs communication with a base station covering the communication areas #1 and #2 in which the mobile terminal device is located, by using, for example, a carrier determined for each type of mobile terminal devices, out of the three carriers #1, #2, and #3. When the mobile terminal device moves and is about to get to a border between the communication areas #1 and #2, a handover to a base station covering an adjacent communication area is executed.

FIG. 2 is a diagram illustrating how handovers are performed when a train passes through a border between communication areas. FIG. 3 depicts a problem in the state illustrated in FIG. 2.

As illustrated in FIG. 2, in the case wherein a large number of users each having a mobile terminal device collectively move by a train or the like, when the train passes through a border between respective communication areas #1 and #2 of two base stations, handovers are simultaneously performed in a large number of mobile terminal devices. As a result, as illustrated in FIG. 3, processing load imposed on the base stations rapidly rises due to the establishment/release of radio resources accompanying the handovers, thereby causing a possibility that the base stations may end up in congested situations. Furthermore, simultaneous transmissions of signals from the large number of mobile terminal devices may cause electric wave interferences, to thereby incur communications failure such as communication delays and/or call disconnections in not only the mobile terminal devices within the train but also in mobile terminal devices of users in the neighborhood.

In this regard, there is known a technique for shifting timing at which mobile terminal devices utilizing carriers pass through a border between communication areas, by a plurality of carriers changing respective communication areas (for example, refer to Japanese Laid-open Patent Publication No. 2005-347976).

FIG. 4 is a diagram illustrating how handovers are performed when a plurality of carriers change respective communication areas.

As illustrated in FIG. 4, by changing the respective communication areas of the plurality of carriers, border locations of respective communication areas of a plurality of base stations shift for each of the carriers. For example, when a large number of mobile terminal devices collectively move by a train or the like, mobile terminal devices utilizing the carrier #3 of which the border location in its communication area is located at the trailing side along a moving direction is subjected to a handover at relatively early timing, while mobile terminal devices utilizing the carrier #1 of which the border location in its communication area is located at the leading side along the moving direction is subjected to a handover at relatively late timing.

Here, as illustrated in FIG. 4, when respective communication areas of a plurality of carriers are shifted in communication area, in view of radio wave states and interferences between communication areas (cells), there is a possibility of causing insensitive areas which are included in no communication areas and within which no electric wave can be received by mobile terminal devices. For this reason, it is preferable that the time period during which communication areas are shifted be reduced as much as possible, for example, in such a way that the time period is limited to a time period when the number of handover requests received by base stations exceeds a predetermined number. Furthermore, when a large number of users each having a mobile terminal devices are moving in a train or the like, a large number of mobile terminal devices simultaneously straddle borders between communication areas, which causes a problem that, even if communication areas are shifted after having received handover requests from the mobile terminal devices, the processing load imposed on the base stations may be incapable of being sufficiently distributed.

### SUMMARY

According to an aspect of the invention, a mobile communication system for communicating with mobile terminal devices, the mobile communication system includes: a plurality of base stations for covering different communication area, respectively, the base station including: a radio communicator for communicating with mobile terminal devices with a plurality of carriers, and a communication controller for changing radio field intensity of the radio communicator; and a management device for managing the plurality of base stations, the management device including: a storage for storing information of each of the base stations, the information including time slots and a number of registration requests from the mobile terminal devices in each communication area of the base station in accordance with the time slots, and an instructor for instructing to change radio field intensity of the plurality of carriers to the radio communicator in the base stations on the bases of the stored information in the storage when the number of the registration requests in the time slot exceed a specified predetermined threshold value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating relationships between base stations and a plurality of carriers.

FIG. 2 is a diagram illustrating how handovers are performed when a train passes through a border between communication areas.

FIG. 3 depicts a problem in the state illustrated in FIG. 2.

FIG. 4 is a diagram illustrating how handovers are performed when a plurality of carriers change respective communication areas.

FIG. 5 is a schematic block diagram of a mobile communication system to which an embodiment of communication system has been applied.

FIGS. 6A and 6B are a diagram illustrating an example of location registration area.

FIG. 7 is a diagram illustrating location registration procedures of the mobile terminal device.

FIG. 8 is a functional block diagram of a radio network controller and two radio base stations.

FIG. 9 is a diagram illustrating an example of management table.

FIG. 10 is a flowchart illustrating a series of processing for generating the management table.

FIG. 11 is a diagram illustrating numbers of location registration requests received by one radio base station.

FIG. 12 is a diagram illustrating an example of a communication area covered by a plurality of radio base stations.

FIG. 13 is a flowchart illustrating a series of processing flow for area change.

FIG. 14 is a diagram illustrating respective communication areas of three carriers #1, #2, and #3.

FIG. 15 is a diagram illustrating borders between communication areas.

FIG. 16 is a diagram illustrating change levels of location registration areas.

FIG. 17 is a diagram illustrating how border locations between location registration areas has been changed using an adaptive array antenna.

FIG. 18 is a diagram illustrating a processing flow in the radio base station.

FIG. 19 is a diagram illustrating a processing flow in the radio network controller.

FIG. 20 is a diagram illustrating an example of management table.

### DESCRIPTION OF EMBODIMENTS

Embodiments will be described with reference to the appended drawings.

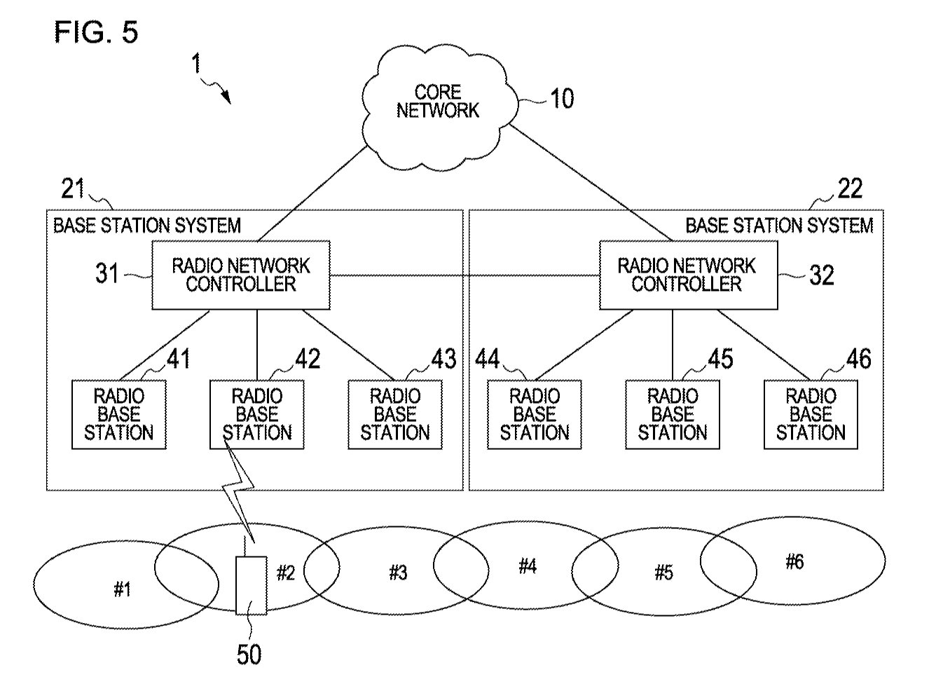

FIG. 5 is a schematic block diagram of a mobile communication system to which an embodiment of the above-described mobile communication system has been applied.

The mobile communication system 1 illustrated in FIG. 5 includes a core network (CN) 10 connected to other communication systems; radio network controllers (RNC) 31 and 32 relaying communication with the core network 10; radio base stations (Node B) 41, 42, 43, 44, 45, and 46, respectively, forming communication areas #1 to #6; and a mobile terminal device 50 having a verbal communication function and an e-mail transmission/reception function. In actuality, the mobile communication system 1 includes a large number of mobile terminal devices and radio base stations, but FIG. 5 only illustrates ones necessary for description of the present embodiments, for the sake of simplification of the figure. Base station systems 21 and 22 including the radio base stations 41, 42, 43, 44, 45, and 46, and the radio network controllers 31 and 32 correspond to one example of mobile communication system. Moreover, the mobile terminal device 50 corresponds to one example of mobile terminal device of the mobile communication system, and the radio base stations 41, 42, 43, 44, 45, and 46 correspond to one example of the base station of the mobile communication system. The combination of the radio network controllers 31 and 32, and the core network 10 corresponds to one example of the management device of the mobile communication system.

The core network 10 has a main server device wherein mobile terminal devices 50 existing in the respective communication areas #1 to #6 of the radio base stations 41, 42, 43, 44, 45, and 46, are registered. Every specified time period, or when the mobile terminal devices 50 straddle a predetermined location registration area because of a movement or the like, each of them requires a location registration of the core network 10 via the base station systems 21 and 22 covering this location registration area.

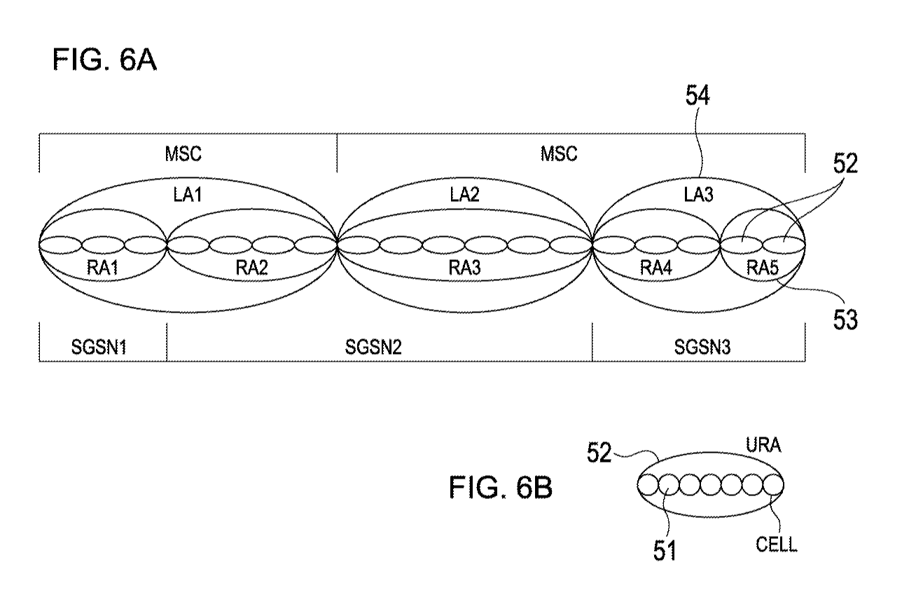

FIGS. 6A and 6B are a diagram illustrating an example of location registration areas.

As illustrated in FIGS. 6A and 6B, a plurality of cells 51 each corresponding to the respective communication areas #1 to #6 of the radio base stations 41, 42, 43, 44, 45, and 46 are put together into an UTRAN registration area (URA) 52; a plurality of the URAs 52 are put together into a rooting area (RA) 53; and a plurality of the RAs 53 are put together into a location area (LA) 54. Sounds, moving images, etc. are controlled by a mobile-services switching center (MSC), and packets are controlled by SGSN managing the RAs 53. In this embodiment, a location registration is required every time the mobile terminal device 50 straddles the LA 54 or the RA 53.

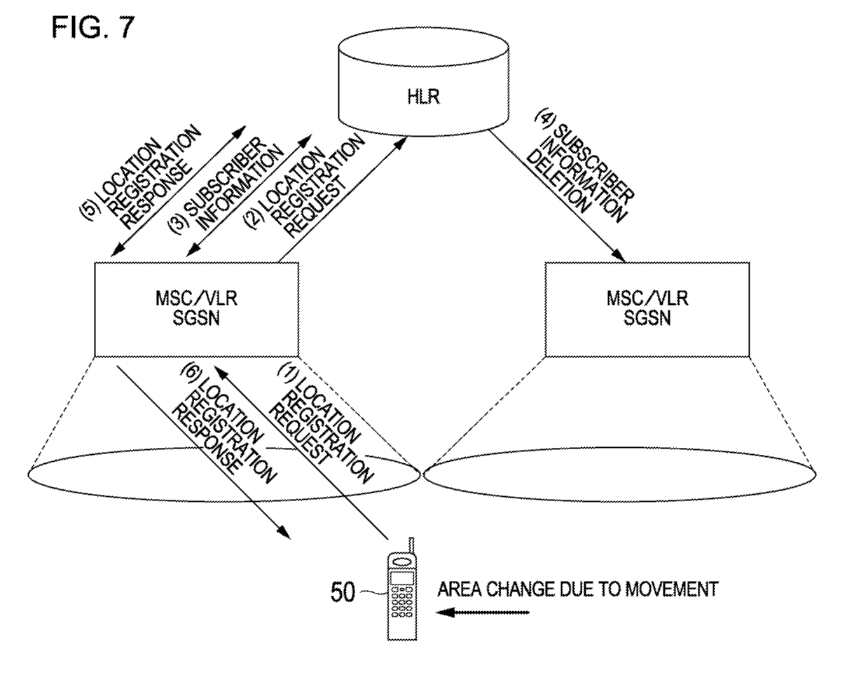

FIG. 7 is a diagram illustrating location registration procedures of the mobile terminal device 50.

In the radio base stations 41, 42, 43, 44, 45, and 46, every specified time period, announcement information including area IDs indicating the communication areas #1 to #6 covered by the respective base stations, is transmitted in a multicast manner, using a plurality of carriers. In the mobile terminal device 50, a carrier ID used for each device type is acquired, and upon receipt of the announce information using the carrier, a location registration area (RA 53, LA 54) corresponding to a location where the mobile terminal device 50 exists is determined. Every specified time period, or when it is determined that the location registration area has changed because of a movement or the like, a location registration request is transmitted to the radio base stations 41, 42, 43, 44, 45, and 46 covering new communication areas #1 to #6 represented by the area ID in the announcement information (step S1).

The location registration request is transmitted from the radio base stations 41, 42, 43, 44, 45, and 46 to the radio network controllers 31 and 32, and further to the core network 10.

In the core network 10, the location registration request is acquired by the MSC or the SGSN covering the new location registration area after the change. The MSC or the SGSN request a location registration of a home location register (HLR) (step S2), and downloads subscriber information on the mobile terminal device 50 stored in the HLR to a visitor location register (VLR) (step S3). The HLR deletes the subscriber information stored in the VLR covering the original location registration area before the change (step 4), and transmits a response indicating that the location registration has been finished, to the mobile terminal device 50 via the MSC and SGSN covering the location registration area after the change (step S5 and step S6).

In this way, the mobile terminal devices 50 in all location registration areas are registered in the HLR, and in the VLR in each location registration area, mobile terminal devices 50 existing in a respect one of the location registration areas are registered.

Here, when the mobile terminal devices 50 move and straddle location registration areas, location registrations as described above are performed, and handover processing is performed between the mobile terminal devices 50 and the radio base stations 41, 42, 43, 44, 45, and 46. As a result, when a train or the like carrying a large number of users passes through borders between location registration areas, handover requests are simultaneously transmitted from a large number of the mobile terminal devices 50. In this embodiment, however, by previously shifting respective communication areas of a plurality of carriers in time slots during which the number of handover requests exceeds a predetermined number, it is possible to achieve distribution of the proceeding load in the radio base stations 41, 42, 43, 44, 45, and 46.

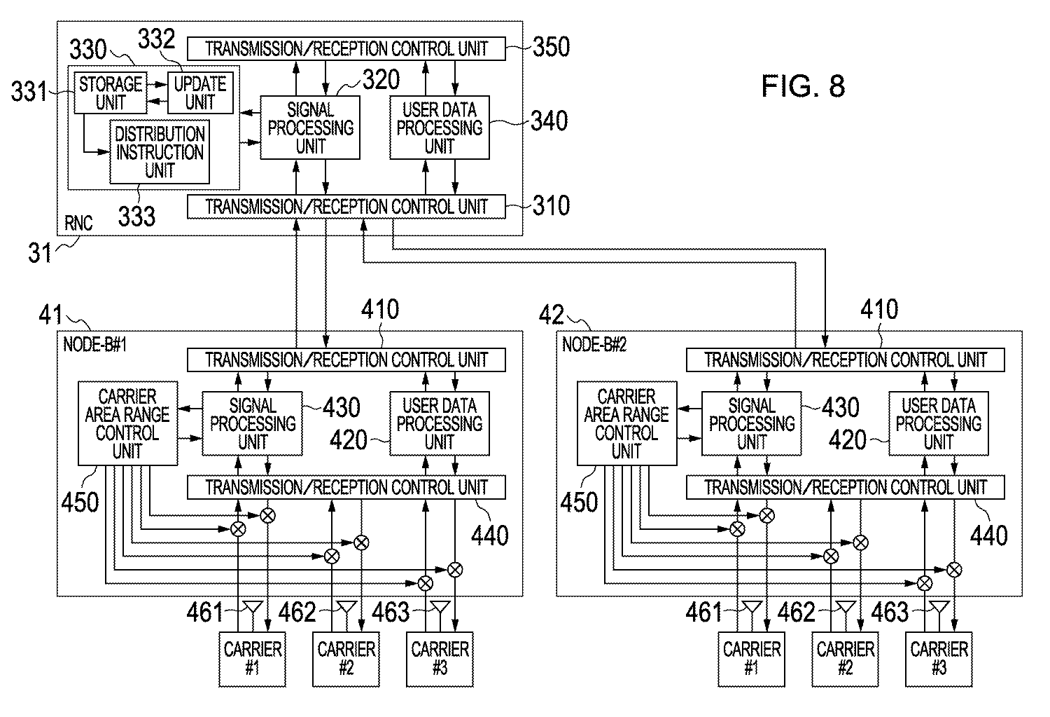

FIG. 8 is a block diagram of a radio network controller 31 and two radio base stations 41 and 42.

Here, the two radio base stations 41 and 42 are illustrated as representatives of the radio base stations 41, 42, 43, etc. In actuality, however, a large number of radio base stations are controlled by the radio network controller 31.

In this embodiment, in the radio base stations 41 and 42, radio communication are performed using mutually different three carriers #1, #2, and #3 (for example, (2 GHz+200 kHz) band, 2 GHz band, and (2 GHz-200 kHz) band).

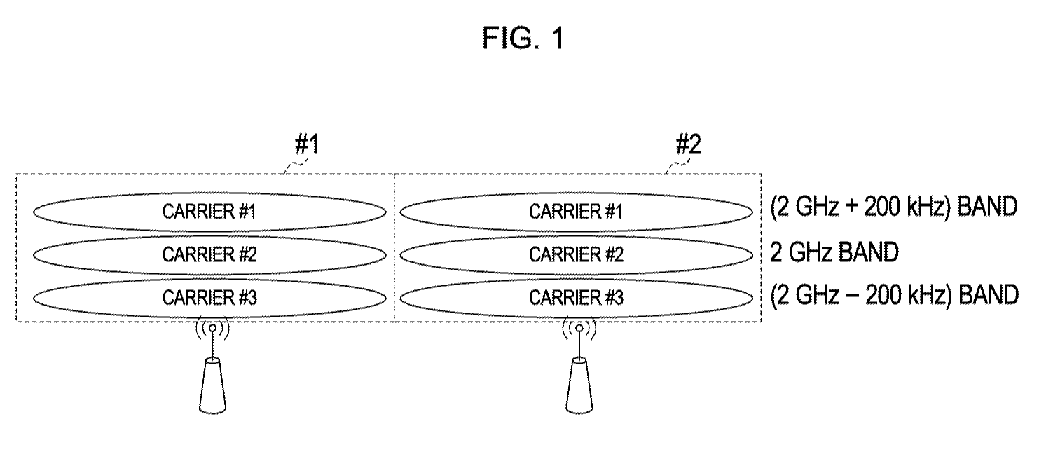

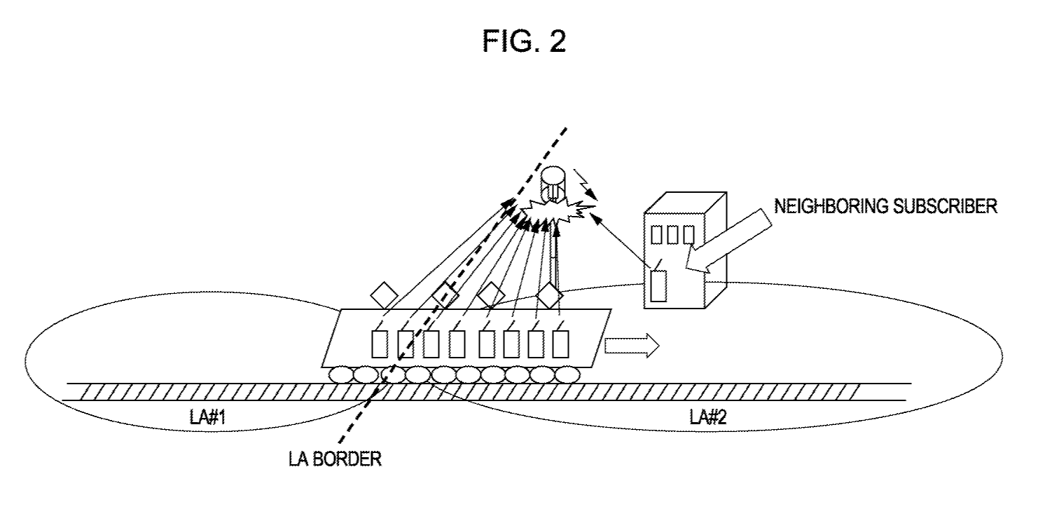

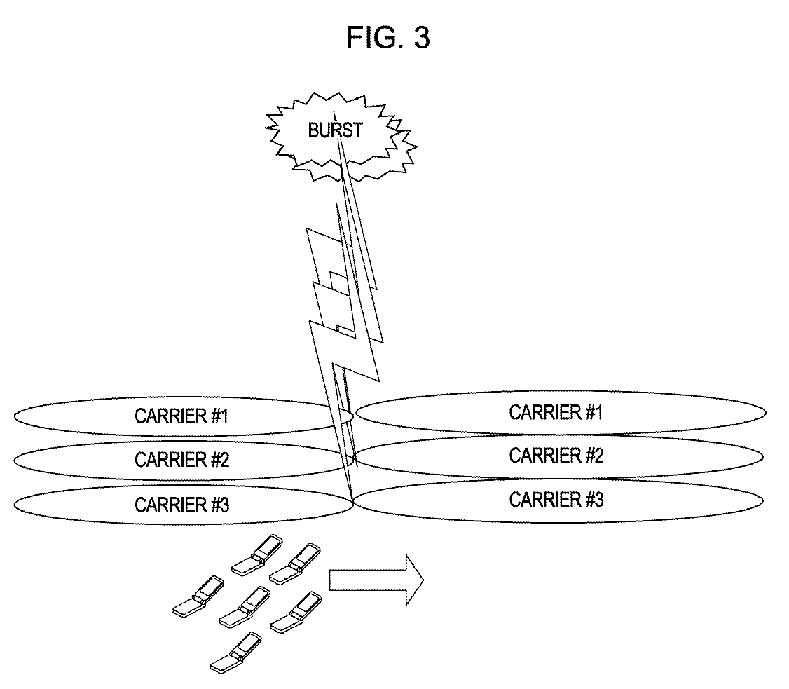

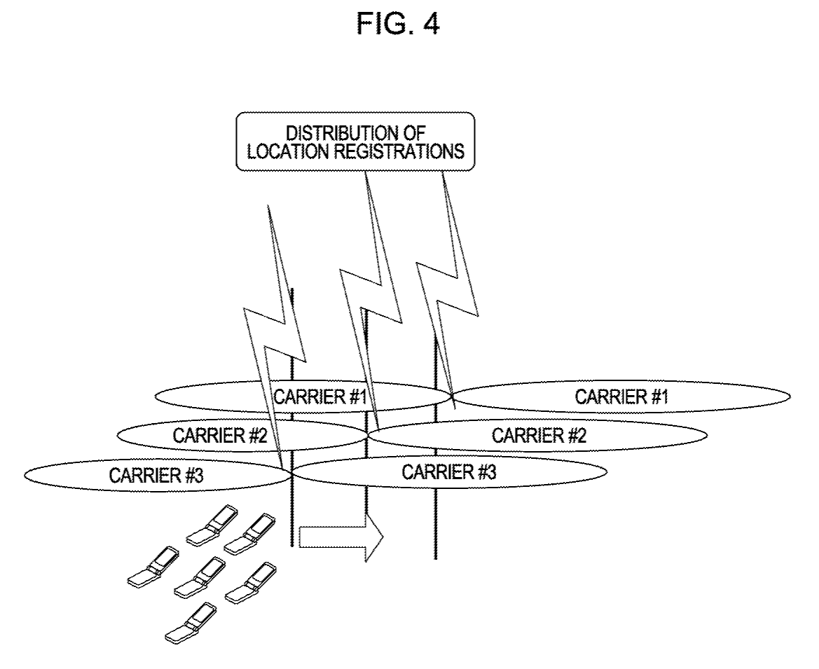

The radio base stations 41 and 42 include: antennas 461, 462, and 463 that transmit/receive three kinds of electric waves using the respective carriers #1, #2, and #3, to/from the mobile terminal devices 50; a transmission/reception unit 440 controlling communication with the mobile terminal devices 50; a user data processing unit 420 processing user data such as sounds or packets; a signal processing unit 430 processing control data such as various requests, responses, instructions or the like; a carrier area range control unit 450 that adjusts communication intensities of electric waves emitted from the respective three respective antennas 461, 462, and 463, to control coverages (communication areas) of the electric waves using the carriers #1, #2, and #3; and a transmission/reception control unit 410 controlling communication with the radio network controller 31. In a state wherein the communication area has not yet been changed, respective radio field intensity of the carriers #1, #2, and #3 are approximately equal to one another. As illustrated in FIG. 1, respective communication area ranges of the carriers #1, #2, and #3 are equal to each other. The transmission/reception unit 440 corresponds to one example of radio communicator in the above-described basic configurations of the mobile communication system, and the carrier area range control unit 450 corresponds to one example of communication controller of the mobile communication system.

The radio network controller 31 includes: a transmission/reception control unit 310 controlling communication with the radio base stations 41 and 42; a user data processing unit 340 processing user data; a signal processing unit 320 processing control data; a location registration monitoring unit 330 monitoring location registrations; and a transmission/reception control unit 350 controlling communication with the core network 10. The location registration monitoring unit 330 further includes: a storage 331 storing a management table (described later) indicating the presence/absence of communication area change per day of week/time slot; an update unit 332 updating the management table; and a distribution instructor 333 notifying the radio base stations 41 and 42 of instructions to change the communication area, on the basis of the management table. The storage 331 corresponds to one example of storage of the mobile communication system, and the distribution instructor 333 corresponds to one example of instructor of the mobile communication system.

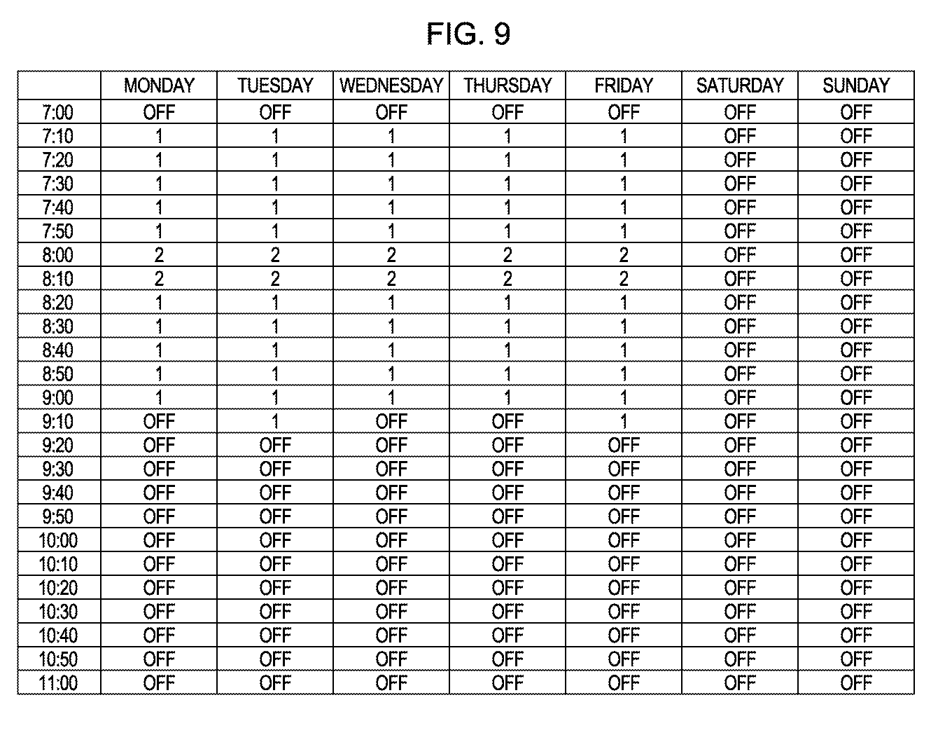

FIG. 9 is a diagram illustrating an example of the management table.

The management table is prepared for each of the plurality of radio base stations, and the day of week and the time slot are related to each other. The vertical axis represents the time slot, and the horizontal axis represents the day of week. In each column, some one of flags “off”, “1”, and “2” is set. Setting of “off” indicates that no communication area change is to be executed on a pertinent day of week/time slot, while setting of “1” or “2” indicates that a communication area change is to be executed to a degree in accordance with a level on a pertinent day of week/time slot.

Firstly, explanation will be given on a method for generating the management table.

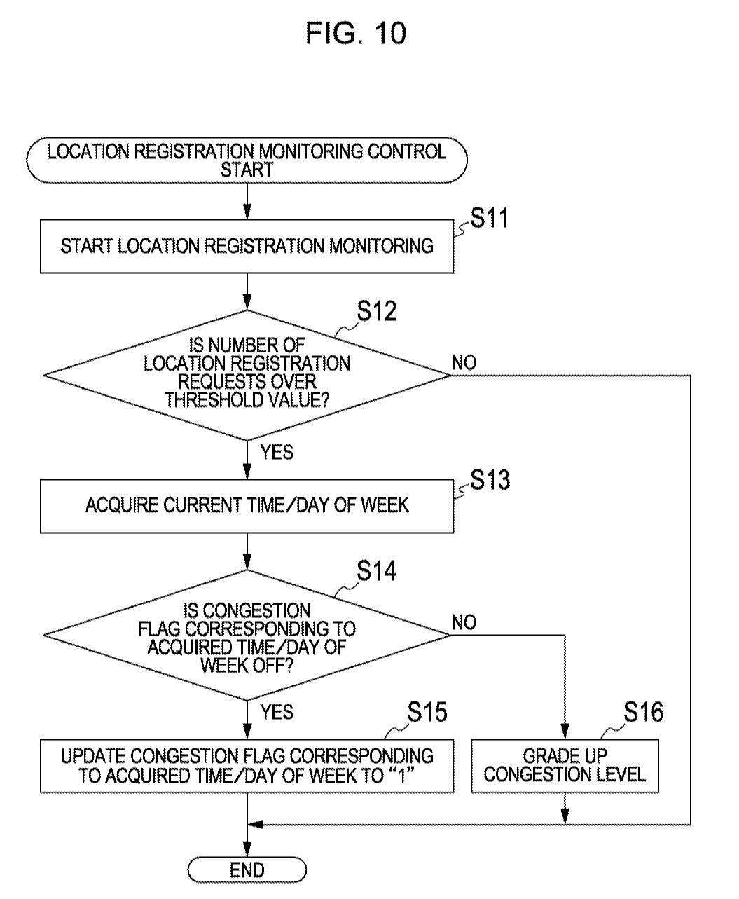

FIG. 10 is a flowchart illustrating a series of processing for generating the management table.

The management table illustrated in FIG. 9 is first prepared in the storage 331, and flags on all columns in the management table are set to “off” (step S11 in FIG. 10). In this state, as illustrated in FIG. 1, respective communication area ranges of the carriers #1, #2, and #3 are equal to one another.

In the mobile terminal devices 50, every specified time period or every time the location registration area is changed, location registration requests are transmitted to the radio base stations 41 and 42 in accordance with the locations of the respective mobile terminal devices 50, using the carriers #1, #2, and #3 previously determined in accordance with a device type or the like.

The location registration requests transmitted from the mobile terminal devices 50 are transmitted to the radio network controller 31 via the radio base stations 41 and 42. In the radio network controller 31, at the update unit 332, the number of location registration requests received per unit time (e.g., 10 min) by each of the radio base stations 41 and 42 is counted. If the number of location registration requests exceeds a specified predetermined threshold value (e.g., 80) (Yes in step S12 in FIG. 10), the current time and day of week are acquired (step 13 in FIG. 10), and the management table of the corresponding radio base stations 41 and 42 is acquired from the storage 331.

In the acquired management table, if a flag in a column corresponding to the acquired time and day of week is “off” (Yes in step S14 in FIG. 10), the flag in the column is updated to “1” (step S15 in FIG. 10)

When the flag in the management table is set to “1”, in the radio base stations 41 and 42 corresponding to the management table, respective communication area ranges of the carriers #1, #2, and #3 are changed to the degree of level 1 determined in advance. A method for changing the communication area range is described later in detail.

Also after the communication area range has been changed, the number of location registration requests exceeds the specified predetermined threshold value (Yes in step 12 in FIG. 10), the current time and day of week are acquired (step 13 in FIG. 10). However, since the flag is not “off” (No in step 14 in FIG. 10), the flag is updated to +1 (step 16 in FIG. 10). By registering a level of area distribution in this way, the processing load imposed on the base stations can be efficiently relieved.

The above-described processing is repeated in this manner until the number of location registration requests transmitted from the mobile terminal devices 50 becomes not more than the specified predetermined threshold value.

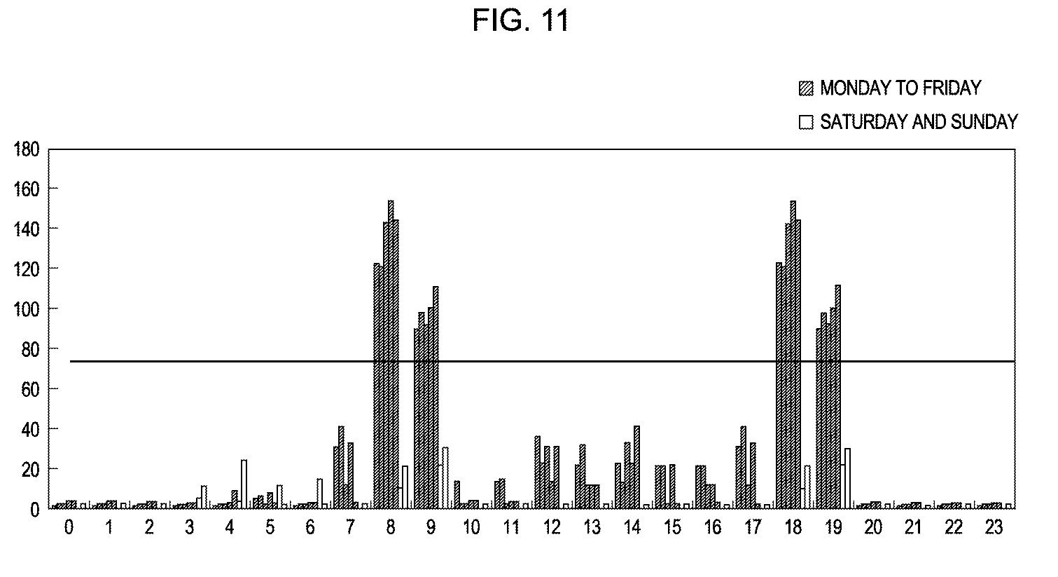

FIG. 11 is a diagram illustrating numbers of location registration requests received by one radio base station.

In FIG. 11, the horizontal axis represents the time slot, and the vertical axis represents the number of location registration requests received by one radio base station, wherein the time slot and the number of location registration requests is related to each other.

As illustrated in FIG. 11, it is recognized that location registration requests received by the radio base station concentrates in the mornings and evenings on weekdays whereas they are small in number over the entire time slots on Saturdays/Sundays.

Here, with respect to the above-described configurations of the mobile communication system, it is preferable that there be provided an application configuration wherein the storage stores values each associating the number of registration requests with a day of week and a time slot during which the registration requests were received, and on the basis of the stored values, instructs the plurality of base stations to change the radio field intensity of each of the plurality of carriers in time slots per day of week, during which the number of registration requests exceeds a specified predetermined threshold value.

By considering the day of week along with the time slot, it is possible to perform efficient area changes in such a way as to perform area changes only in rush hours on week days.

Next, a specific method for area change will be described.

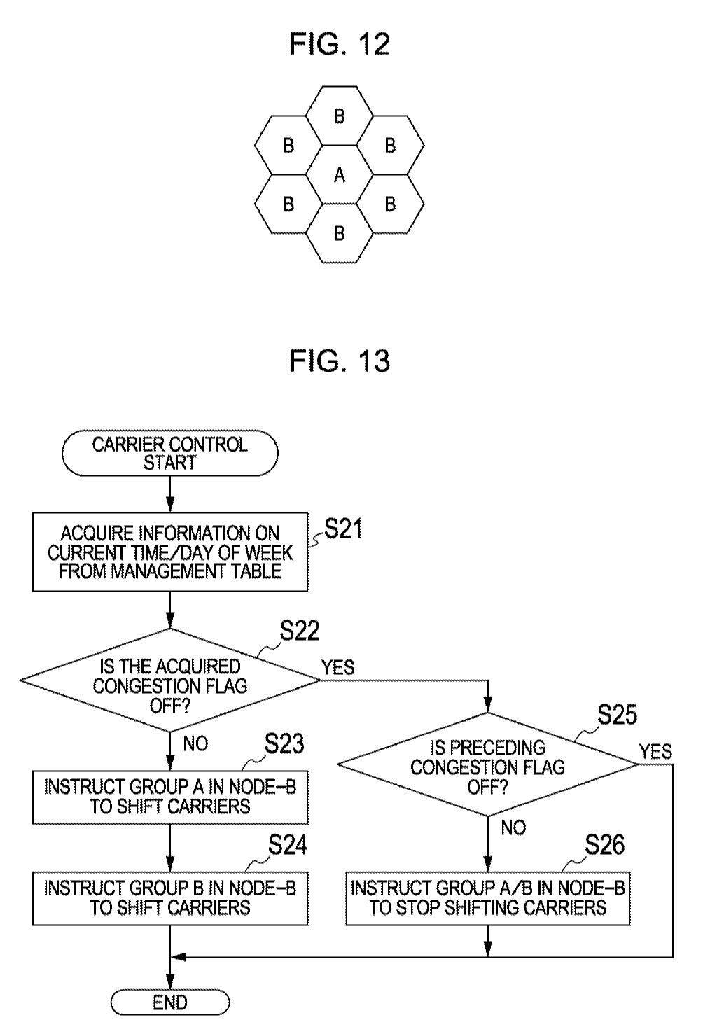

FIG. 12 is a diagram illustrating an example of respective communication areas covered by a plurality of radio base stations.

For example, when the number of location registration requests received by a radio base station 40_A exceeds the threshold value, area changes are executed not only in the radio base station 40_A, but also in radio base stations 40_B adjacent to the radio base station 40_A.

FIG. 13 is a flowchart illustrating a series of processing flow for area change.

In the radio network controller 31, at the distribution instructor 333, the management table stored in the storage 331 is referenced every specified time period, to acquire a flag in a column corresponding to the current day of week/time (step S21 in FIG. 13).

If the acquired flag is a value other than “off” (No in step S22 in FIG. 13), an instruction to perform an area change at a level indicated by a value of the flag is provided to the radio base station 40_A corresponding to the management table (step S23 in FIG. 13). In the radio base station 40_A, at the carrier area range control unit 450, respective radio field intensities of the carriers #1, #2, and #3 emitted from the antennas 461, 462, and 463, respectively, are changed to degrees in accordance with respective indicated levels, and adjusted so that coverages (communication areas) of the three carriers #1, #2, and #3 are shifted relative to one another. In this embodiment, the radio field intensity of the carrier #1 is changed to a lower value while that of the carrier #3 is changed to a higher value.

Furthermore, in the radio network controller 31, an instruction to perform area change is provided also to each of the radio base stations 40_B adjacent to the radio base station 40_A (step S24 in FIG. 13). In the radio base stations 40_B, their communication areas are adjusted so that communication areas of the three carriers #1, #2, and #3 become complementarily adjacent to communication areas of the three carriers #1, #2, and #3 of the radio base station 40_A. In this embodiment, the radio field intensity is changed to a lower value while that of the carrier #3 is changed to a higher value.

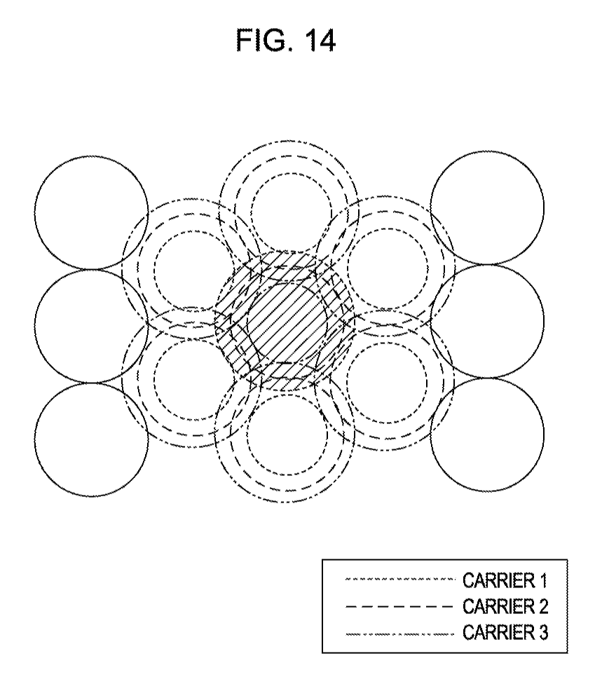

FIG. 14 is a diagram illustrating respective communication areas of the three carriers #1, #2, and #3.

As illustrated in FIG. 14, in the radio base station 40_A represented by hatch lines, respective communication area ranges of the three carriers #1, #2, and #3 are shifted relative to one another, and the communication area of the carrier #1 is changed to be wider while that of the carrier #3 is changed to be narrower. Furthermore, in the radio base stations 40_B adjacent to the radio base station 40_A, the communication area of the carrier #1 is changed to be narrower while that of the carrier #3 is changed to be wider, contrary to the radio base station 40_A.

Here, with respect to the above-described configurations of the mobile communication system, it is preferable that there be provided an application configuration wherein the instructor, when instructing any one of the plurality of first base stations to change a radio field intensity of each of the plurality of carriers, instructs a second base station adjacent to the first base station to change its field density complementarily with respect to a communication area of the first base station. It is also preferable that there be provided an application configuration wherein the communication controller changes the radio field intensity of the plurality of carriers in an omnidirectional manner.

Regarding not only the radio base station 40_A wherein the number of location registration requests exceed the threshold value, but also regarding the radio base stations 40_B adjacent to the radio base station 40_A, complementarily changing communication areas enables to prevent an occurrence of a problem that insensitive areas disallowing to receive electric waves may arise, which allows reliability of communication to be maintained. Furthermore, by adjusting the radio field intensity to change the communication area in an omnidirectional manner, the communication area can be easily controlled.

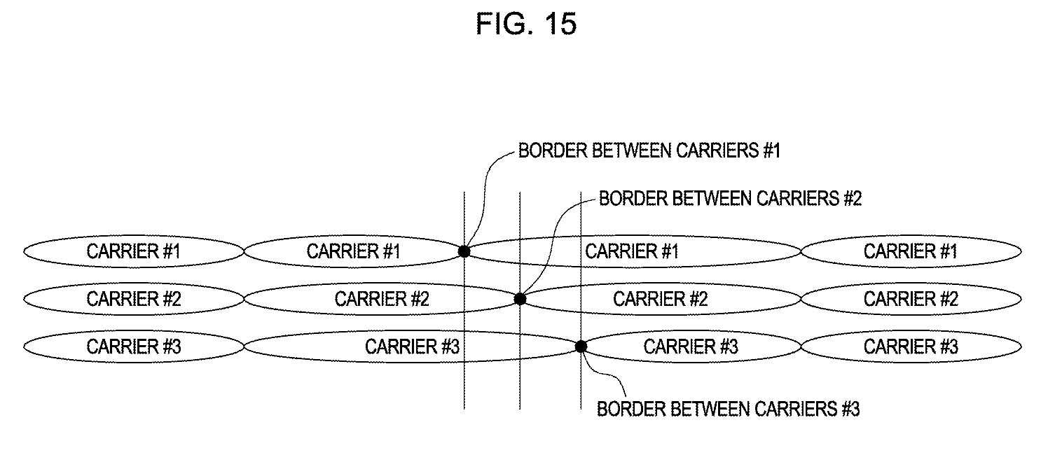

FIG. 15 is a diagram illustrating borders between communication areas.

As illustrated in FIG. 15, by changing the radio field intensity of each of the three carriers #1, #2, and #3, the respective communication areas of the carriers #1, #2, and #3 are shifted relative to one another. For example, when a large number of the mobile terminal devices 50 move by a train or the like from the left to the right in FIG. 15, the mobile terminal devices 50 utilizing the carrier #1 earliest straddle the border between location registration areas, and transmits a location registration request at relatively early timing. Next, the mobile terminal device 50 utilizing the carrier #2 transmits a location registration request, and lastly, the mobile terminal device 50 utilizing the carrier #3 transmits a location registration request. In this embodiment, since changes of communication area range are performed in advance at rush hours in the mornings and evenings, the processing load imposed on the radio base stations can be distributed, thereby allowing relief of communication failures.

In the case wherein the flag acquired in the radio network controller 31 is “off” (Yes in step S22 in FIG. 13), if the preceding flag was a value other than “off” (No in step S25 in FIG. 13), the number of location registration requests transmitted from the mobile terminal devices 50 has already decreased, and therefore, an instruction to restore the communication area range is provided to the radio base station 40_A and each of the radio base stations 40_B (step S26 in FIG. 13).

In each of the radio base station 40_A and the radio base stations 40_B, at the carrier area range control unit 450, the radio field intensity of each of the carriers #1, #2, and #3 emitted from the respective antennas 461, 462, and 463 is restored, and adjusted so that the respective communication areas of the three carriers #1, #2, and #3 become equal to one another.

In this way, according to the present embodiment, in time slots during which a large number of mobile terminal devices move by trains or the like, changes of area ranges can be performed in advance, which enables distribution of the processing load imposed on the radio base stations.

The description of the first embodiment is ended here, and a second embodiment will now be described. The second embodiment is different from the first embodiment only in a generating method for the management table, and hence, FIG. 8 is used also for the second embodiment, and description of the second embodiment is focused on just the difference from the first embodiment.

In the radio network controller 31 according to the first embodiment, numbers of location registration requests transmitted from mobile terminal devices 50 every day of week/time slot have been counted, and management tables as illustrated in FIG. 9 have been generated. In this embodiment, however, management tables are each generated by reference to e.g., a time table of a train.

In general, the location registration of the mobile terminal device 50 is completed within one second. For example, letting the speed of a train be 80 km/h, the train travels 22.2 m per second, and so, if the location registration area of each of the carriers #1, #2, and #3 is shifted by about 23 m, congestion in radio base stations can be relieved. Therefore, the change level of location registration area can be determined on the basis of the speed of train or the like passing through borders between location registration areas.

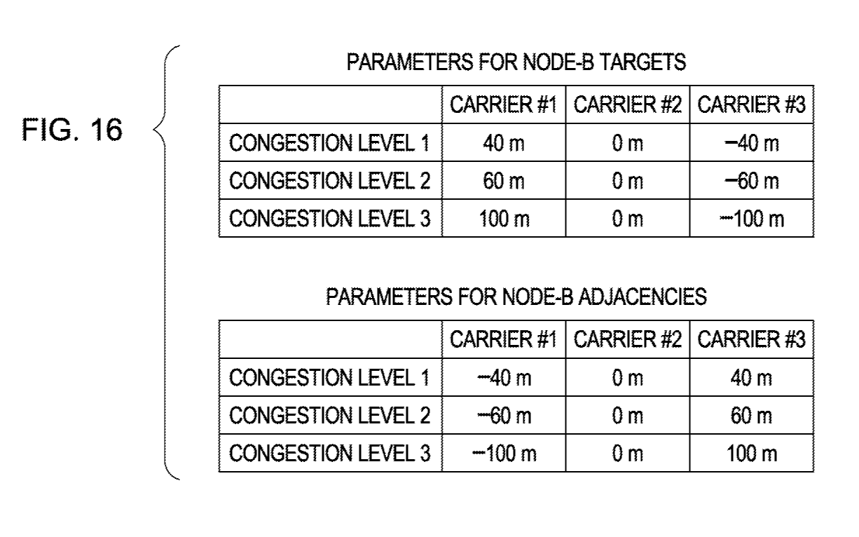

FIG. 16 is a diagram illustrating change levels of location registration areas.

In this example, three change levels are prepared in response to the speed of train. In the case of an ordinary train, location registration areas of the three carriers #1, #2, and #3 of a corresponding radio base station 40_A are changed by 40 m, 0 m, and −40 m, respectively. In the radio base stations 40_B adjacent to the radio base station 40_A, location registration areas of the three carriers #1, #2, and #3 are changed by −40 m, 0 m, and 40 m, respectively, contrary to the case of the radio base station 40_A. Likewise, for a comparatively high-speed train, location registration areas of the three carriers #1, #2, and #3 of the radio base station 40_A are changed by 60 m, 0 m, and −60 m, respectively, and for Shinkansen (a Japanese bullet train) or the like, location registration areas of the three carriers #1, #2, and #3 of the radio base station 40_A are changed by 100 m, 0 m, and −100 m, respectively.

In this way, also by changing the change level of location registration area in accordance with the speed of train or the like, the processing load imposed on the radio base stations can be relieved, as well.

The description of the second embodiment is ended here, and a third embodiment will now be described. The third embodiment is different from the first embodiment in that location registration areas are changed only in a specified direction, but has substantially the same configuration as that of the first embodiment. Hence, description of the third embodiment is also focused on just the difference from the first embodiment.

Recently, the adaptive array antenna composed of a plurality of array antennas and capable of control directivity by adjusting a weight in each of the array antennas, is widely known. In this embodiment, border locations between location registration areas are changed only in a specified direction, using the adaptive array antenna.

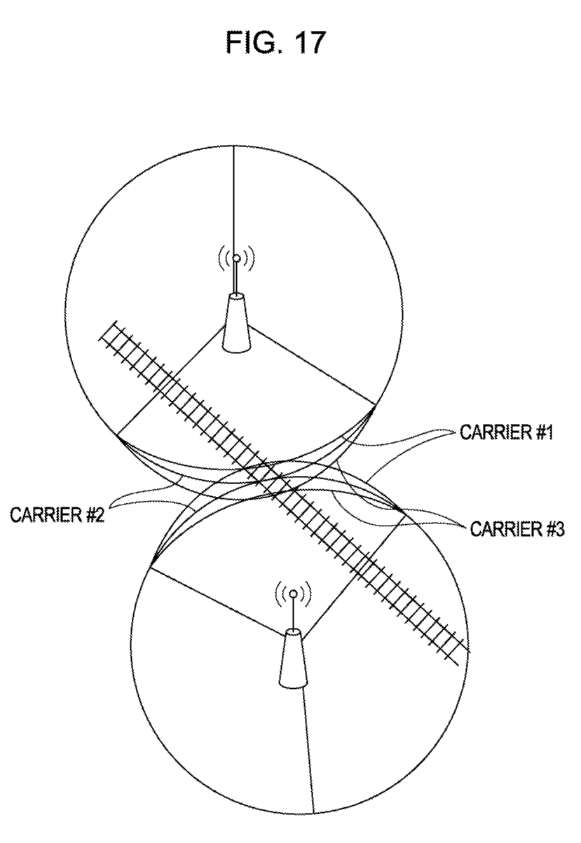

FIG. 17 is a diagram illustrating how border locations between location registration areas have been changed using an adaptive array antenna.

In the example illustrated in FIG. 17, respective location registration areas of the three carriers #1, #2, and #3 are changed only in the direction of a position P where a burst has occurred.

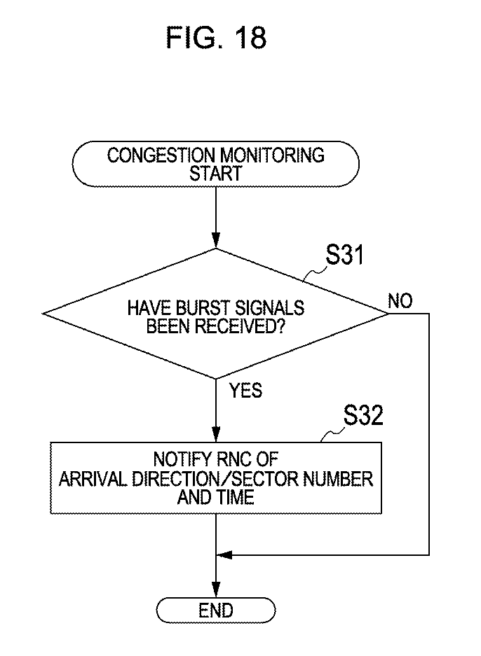

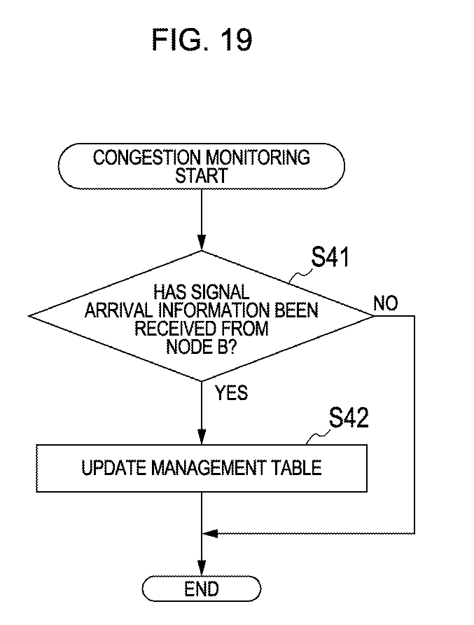

FIG. 18 is a diagram illustrating a processing flow in the radio base station. FIG. 19 is a diagram illustrating a processing flow in the radio network controller.

In the radio base station, upon receipt of burst signals in the adaptive array antenna (Yes in step S31 in FIG. 18), an arrival direction in which the burst signals have been transmitted, and a sector number are transmitted to the radio network controller (step S32 in FIG. 18). In this embodiment, weight information is utilized as the arrival direction.

When the radio network controller receives the arrival direction and the sector number from the radio base station (Yes in step S41 in FIG. 19), they are associated with the current time/day of week to update the management table (step S42 in FIG. 19)

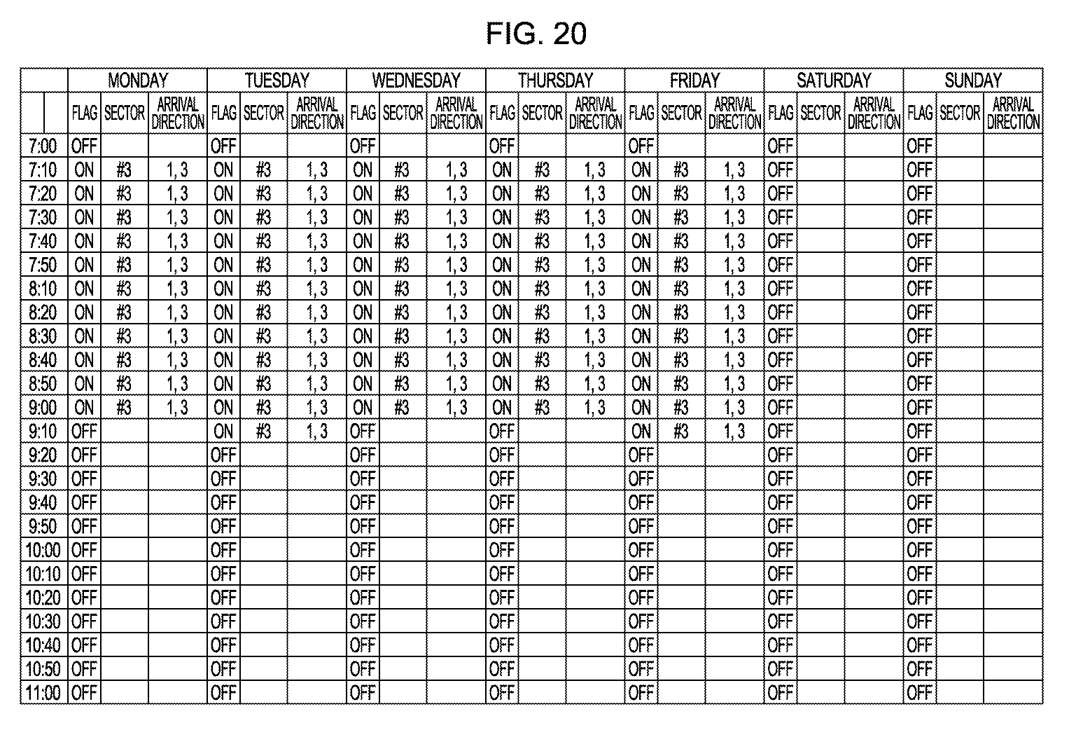

FIG. 20 is a diagram illustrating an example of management table.

In the management table illustrated in FIG. 20, the day of week and the time slot are associated with the flag, the sector number, and the arrival direction. In the radio network controller, the management table illustrated in FIG. 20 is referenced every specified time period. If a flag in a column corresponding to the current time/day of week is “on”, the sector and the arrival direction are transmitted to the radio base station. In the radio base station, on the basis of the transmitted arrival direction and sector number, respective location registration areas of the three carriers #1, #2, and #3 are changed.

Here, with respect to the above-described communication system, it is preferable that there be provided an application configuration wherein the above-described communication controller changes the radio field intensity of each of the plurality of carriers in a specified direction.

By executing area distribution only in the direction in which the burst has occurred, using the adaptive array antenna, it is possible to easily suppress the processing load imposed on the radio base stations without the need to significantly change the location registration area.

In the forgoing descriptions, as an example of mobile terminal, mobile phone has been taken, but the mobile terminal may instead be a personal digital assistant (PDA), a portable game machine, or the like.

As described above, according to the mobile communication system, the management device, and the communication area changing method that are disclosed in the embodiments, even if a large number of mobile terminal devices collectively move by a train or the like, the processing load imposed on the base stations can be distributed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A mobile communication system for communicating with a mobile terminal device, the mobile communication system the comprising:
a plurality of base stations for covering different communication area, respectively, the base station including:
a radio communicator for communicating with the mobile terminal device with a plurality of carriers, and
a communication controller for changing radio field intensity of the radio communicator; and
a management device for managing the plurality of base stations, the management device including:
a storage for storing information of each of the base stations, the information including time slots and a number of registration requests from the mobile terminal devices in each communication area of the base station in accordance with the time slots, and
an instructor for instructing to change radio field intensity of the plurality of carriers to the radio communicator in the base stations on the bases of the stored information in the storage when the number of the registration requests in the time slot exceed a specified predetermined threshold value.

2. The mobile communication system of claim 1, wherein the information includes the day of the week in accordance with the time slots and the number of registration requests; and wherein the instructor for instructing to change radio field intensity of the radio communicator when the number of the registration requests in the time slot of the day of the week exceed the specified predetermined threshold value.

3. The mobile communication system of claim 1, wherein the communication controller changes the radio field intensity of the plurality of carriers in an omnidirectional manner.

4. The mobile communication system of claim 1, wherein the communication controller changes the radio field intensity of the plurality of carriers in a specified direction.

5. The mobile communication system of claim 1, wherein the radio communicator transmits arrival direction information of a signal from the mobile terminal device to the management device; wherein the storage stores the transmitted an arrival direction information from the radio communicator in accordance with the time slot and the number of registration requests on the bases of each of the base stations; wherein the instructor transmits the arrival direction information to the base station on the bases of the stored information in the storage when the number of the registration requests exceeds the specified predetermined threshold value in time slots; and wherein the communication controller changes the radio field intensity of the plurality of carriers in accordance with an instruction on the bases of the arrival direction information from the instructor.

6. The mobile communication system of claim 1, wherein the base stations include a first base station and a second base station adjacent to the first base station; and wherein the instructor instructs to change the radio field intensity of the first base station in a complementarily manner with the second base station when the instructor instructs to change the radio field intensity of the plurality of carriers of the second base station.

7. A mobile communication management device for managing base stations, each of the base stations communicating with mobile terminal devices, the mobile communication management device comprising:
a storage for storing information of each of the base stations, the information including time slots and a number of registration requests from the mobile terminal devices in each communication area of the base station in accordance with the time slots, and
an instructor for instructing to change radio field intensity of the base station on the bases of the stored information in the storage when the registration requests in the time slot exceed a specified predetermined threshold value.

8. A controlling method for a mobile communication system including a plurality of base stations for covering different communication area, respectively, and for communicating with mobile terminal devices, and a management device for managing the plurality of base stations, the controlling method comprising:
storing information of each of the base stations, the information including time slots and a number of registration requests from the mobile terminal devices in each communication area of the base station in accordance with the time slots;
instructing to change radio field intensity of the base stations on the bases of the stored information when the registration requests in the time slot exceed a specified predetermined threshold value; and
changing radio field intensity of the base station.
